(19) United States
(12) Patent Application Publication
(10) Pub. No.: US 2014/0199134 A1
(43) Pub. Date: Jul. 17, 2014

(54) STA-PUT / HURRICANE NAIL

(71) Applicant: OTTO MORALES, Winderemere, FL (US)

(72) Inventor: OTTO MORALES, Winderemere, FL (US)

(21) Appl. No.: 13/742,421

(22) Filed: Jan. 16, 2013

(51) Int. Cl. F16B 15/00

(52) U.S. Cl. CPC F16B 15/00
USPC 411/487

(57) ABSTRACT

The Sta-Put/Hurricane nail has longitudinal anchoring feature located at the driving point of the nail and/or along the shaft. The longitudinal anchor barbs (hook like barb) actively engage the wood (substrate) material when driven through to provide a superior mechanical bond between two or more pieces of wood material than conventional nails. The notched longitudinal anchor barb actively engages the wood (substrate) when force is applied in opposite direction of that of the driven direction. The barbs provide and maintain superior fastening properties during sustained high velocity windstorms (hurricane, tornadoes, etc.) and effectively resist the “popping out” effect of conventional nails due to weathering and aging. The “popping out” effect is when the nail fails and begins to extract itself, thus weakening and subsequently failing.

### BACKGROUND OF INVENTION

This invention relates to fastener improvement and particularly to fasteners useable as strip or coil fasteners for powered hammering tools or manually employed hammering device(s) used in the housing construction industry for mechanically fastening wood elements such as a roof.

### SUMMARY OF INVENTION

This invention illustrates a simple cost effective fastener used to secure wood construction. The ring shank nails are unsuitable for many home construction projects. Many of these nails fail because none exhibit the superior ability of the Sta-Put/Hurricane nail to secure and maintain the mechanical wood bond and avoid the “popping out” effect. The notched longitudinal anchors increase the surface area of the Sta-Put/Hurricane nail thus exposing more wood to the anchoring properties of the Sta-Put/Hurricane nail (FIG. 3).

Another objective is the use of less nails where a strong mechanical bond is required. This will save both in labor and material cost.

### BRIEF DESCRIPTION OF DRAWINGS

The drawing referenced below illustrates the preferred embodiment that is intended to illustrate and not to limit the invention or the feature (hook, barb, etc.) which makes this nail unique in its ability to “bite” into the wood substrate.

FIG. 1 is a drawing which depicts a common wood nail labeling the major salient features.

FIG. 2 is a side by side comparison of the Sta-Put/Hurricane nail (depicting various embodiments) with a common wood nail.

FIG. 3 is a cut away view of wood substrate illustrating and comparing how the Sta-Put/Hurricane nail and a common wood nail interact with the bonding material.

FIG. 4 is a depiction of the salient features of the Sta-Put/Hurricane nail. Show in one of its many embodiments

FIG. 5 is a detailed depiction of the Sta-Put/Hurricane nail

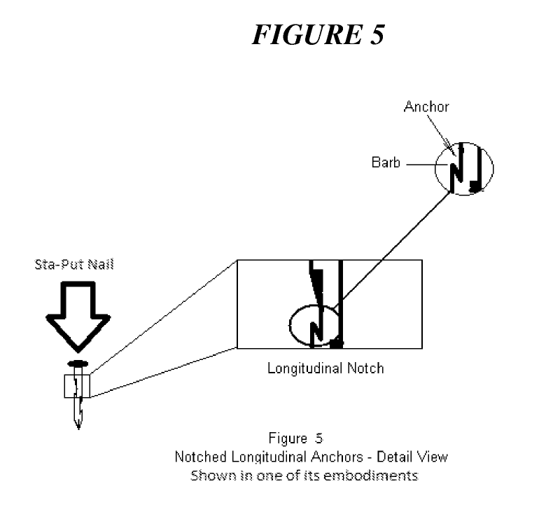

### DETAILED DESCRIPTION

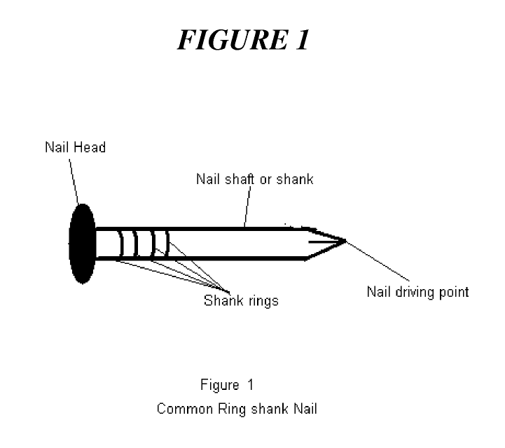

Ordinary ring shank wood nails are generally employed throughout the construction industry (FIG. 1). Specifically, ring shank wood nails are used to secure pieces of wood used in the construction of structures. Over time and exposure to the elements, ring shanks wood nails lose their design features to maintain and stay securely fasten by working their way out of the wood. This is known as the “popping out” effect. The ring shank wood nail exhibits a “popping out” effect. The “popping out” effect is when the wood nail fails and begins to extract itself, thus weakening and subsequently causing failure. The poor fastening properties of ring shank wood nails were evident during high velocity (hurricane) windstorms when roofing structures failed. Ring shank wood nails failed to fasten and secure roofing structures, especially during exposure to high velocity winds, such as those of a hurricane and/or tornadoes. Property damaged from failed roofs totaled into the billions and resulted in loss of life.

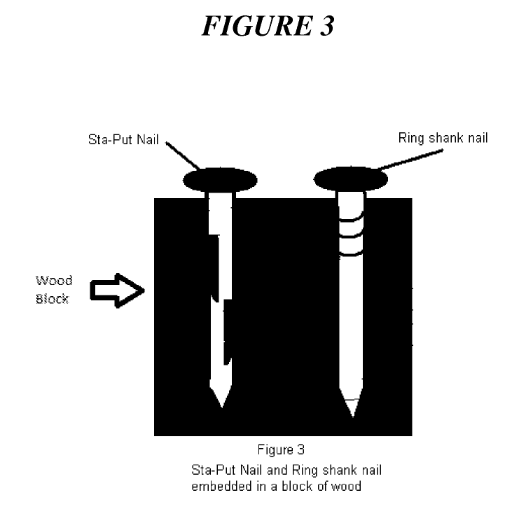

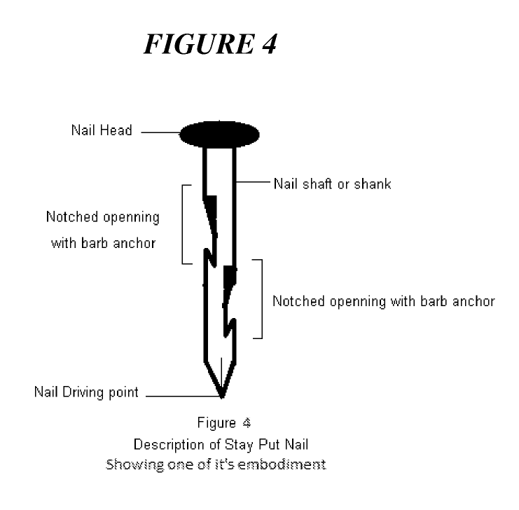

The Sta-Put/Hurricane nail addresses and corrects this “popping out” effect by providing longitudinal anchoring features (FIGS. 4 & 5). Prevention from “popping out” is achieved when notched longitudinal anchors barb (hook like barb) engage the wood (substrate) material and prevent the “popping out” effect and its subsequent consequences of failure (FIG. 3). In addition, the notched longitudinal anchor barb actively engages the wood (substrate) to provide and maintain superior fastening properties during sustained high velocity windstorms (hurricane, tornadoes, etc).

We claim:

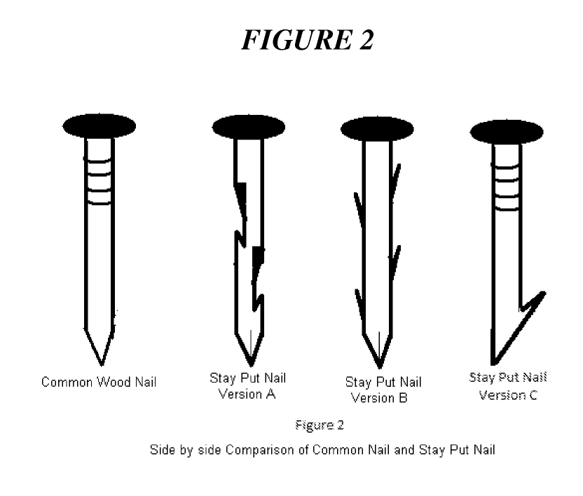

1. The Sta-Put/Hurricane nail is a fastener that prevents the “popping out” effects which plaques the common shank wood nail by and failure of common nails in high velocity winds exposure to maintain a mechanical bond by employing longitudinal anchors. The longitudinal anchors (FIG. 2) are found notched at the shaft/shank/point of the fastening nail. The notched longitudinal anchors have a barb pointed in the opposite direction to which the fastener is driven.

2. The frictional contact between wood and the Sta-Put/Hurricane nail is further increased because of the greater surface area provided by the longitudinal anchors. The Sta-Put/Hurricane nail because of its described features made in claim 1, exhibit a superior ability to maintain and stay securely fasten over ring shank wood nails and nails using a spiral groove or utilizing both. When driven into wood, the Sta-Put/Hurricane nail allows the wood to expand into the notched longitudinal anchors and engage the barbs. The barbs are designed to increase the fastening and holding properties of the Sta-Put/Hurricane nail.

3. When force is applied in the opposite direction of the driven Sta-Put/Hurricane nail, the longitudinal anchoring feature engages the wood substrate material, preventing any mechanical bond failure.

4. Less of the Sta-Put/Hurricane nails are required to secure a mechanical bond thus saving time, money, material and labor costs.
